(19) United States
(12) Patent Application Publication
(10) Pub. No.: US 2008/0211258 A1
(43) Pub. Date: Sep. 4, 2008

(54) Door handle reinforcement plate

(76) Inventors: Daniel Edward Jenks, Gasport, NY (US); Neil Anton Jenks, Livonia, MI (US)

Correspondence Address: Neil Anton Jenks, 19143 Shadyside, Livonia, MI, 48152, US

(21) Appl. No.: 12/011,110

(22) Filed: Jan. 24, 2008

Related U.S. Application Data
(60) Provisional application No. 60/886,529, filed on Jan. 25, 2007.

(51) Int. Cl. B60J 5/00

(52) U.S. Cl. 296/146.6

(57) ABSTRACT

A door handle reinforcement plate that is positioned on the inner surface of a vehicle door. The plate is mounted using the fasteners of the existing door handle. The door handle reinforcement plate adds strength and rigidity to the vehicle door to prevent the vehicle door from flexing or distorting in an undesirable fashion.

### RELATED APPLICATIONS

The present application is based on, and claims priority from, Provisional Application No. 60/886,529, filed Jan. 25, 2007, the disclosure of which is hereby incorporated by reference herein in its entirety.

### BACKGROUND OF THE INVENTION

The present invention generally relates to a method and device that aids in vehicle restoration, and more particularly to a reinforcement plate for a door handle of a vehicle.

Restoration of vintage and classic automobiles is a common hobby for many car enthusiasts. Restoration may involve purchasing a classic or vintage automobile, obtaining the necessary parts to restore the vehicle, performing the work necessary to assemble the parts, etc. In many cases, finding the parts necessary to adequately restore a vehicle in and of itself is a difficult task.

Vehicle doors of classic or vintage automobiles often require restoration. The vehicle doors of older cars are often manufactured from a single sheet of metal of a relatively small thickness. The vehicle door includes a door handle which is received and secured through openings extending through the sheet metal. Over time, repetitive pushing and pulling on the door handle may weaken the metal surrounding the door handle. Disadvantageously, the metal surrounding the door handle may eventually dimple, buckle or bubble, which may detract from the overall appearance of the restored vehicle.

Accordingly, it is desirable to provide a reinforced vehicle door handle which is strengthened in the area of the vehicle door surrounding the door handle and is of a simple design that is easy to manufacture.

### BRIEF DESCRIPTION OF THE DRAWINGS

The various features and advantages of this invention will become apparent to those skilled in the art from the following detailed description. The drawings that accompany the detailed description can be briefly described as follows:

FIG. 1 illustrates a vehicle door having an example door handle reinforcement plate;

FIG. 2 is a schematic side view of the vehicle door illustrated in FIG. 1;

FIG. 3 illustrates the example door handle reinforcement plate;

FIG. 4 is a front view of the example door handle reinforcement plate illustrated in FIG. 3; and

FIG. 5 illustrates a method for reinforcing a vehicle door.

### DETAILED DESCRIPTION OF THE PREFERRED EMBODIMENT

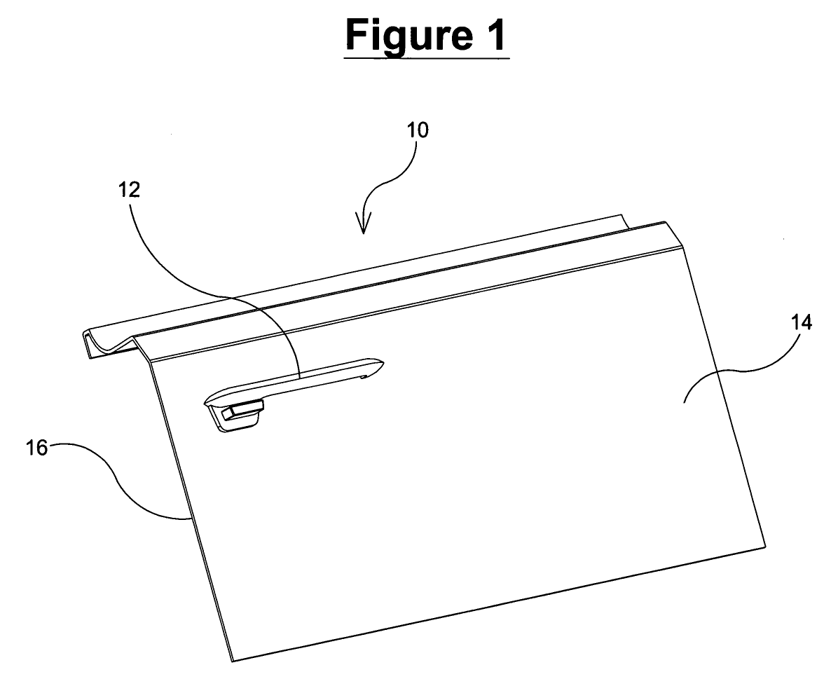

FIG. 1 illustrates a vehicle door 10 having a door handle 12. The vehicle door 10 includes an outer surface 14 and an inner surface 16. The outer surface 14 faces the exterior of a vehicle, while the inner surface 16 faces an interior compartment of a vehicle.

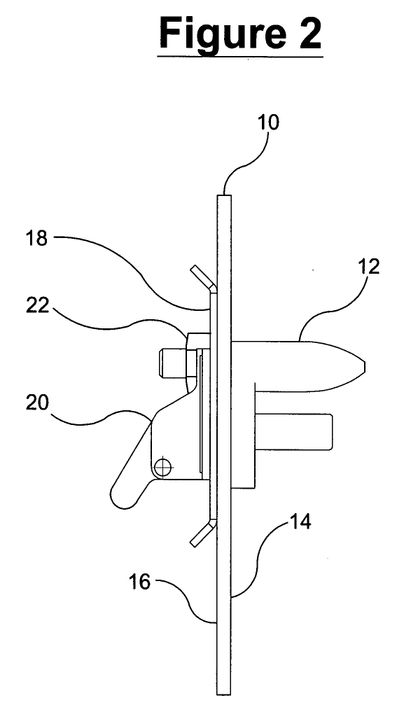

A reinforcement plate 18 is positioned at the inner surface 16 of the vehicle door 10 directly adjacent to the door handle 12 (See FIG. 2). A latching mechanism 20 of the door handle 12 is received through the reinforcement plate 18. A plurality of fasteners 22 attach the reinforcement plate 18 to the door handle 12 and tightly secure the reinforcement plate 18 and the door handle 12 to the vehicle door 10. The reinforcement plate 18 provides increased structural integrity of the door handle 12 relative to the vehicle door 10 and prevents the dimpling or buckling of the area of the vehicle door 10 which surrounds the door handle 12. The example vehicle door 10, the example door handle 12 and the example reinforcement plate 18 illustrated and described herein are not limited to any particular size and shape and may vary depending upon the model of vehicle these components accompany.

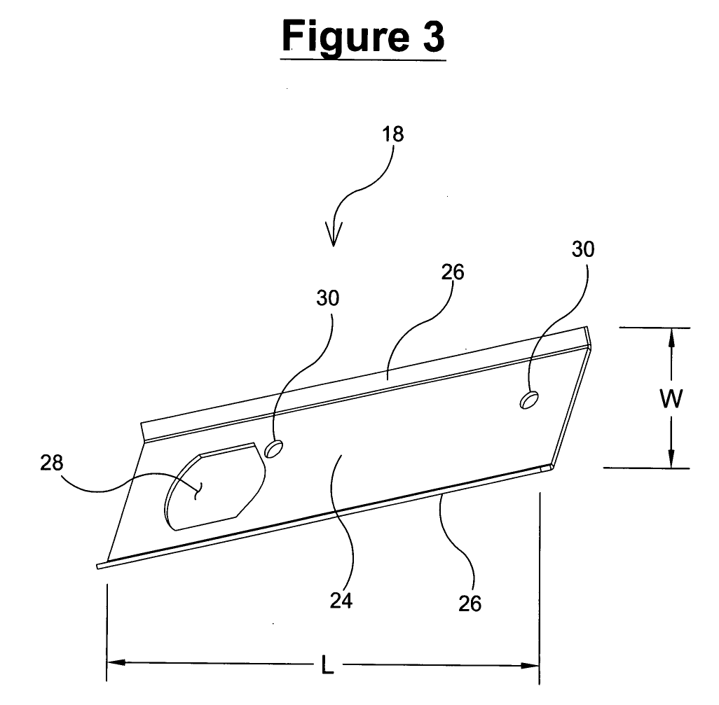

FIG. 3 illustrates the example reinforcement plate 18. In the example shown and discussed herein, only a left handed reinforcement plate 18 for the vehicle doors 10 of the left side of a vehicle is shown for clarity. Those skilled in the art will understand that a right handed reinforcement plate for the vehicle doors of the right side of the vehicle could be a mirror image of the left handed reinforcement plate 18 illustrated and described herein.

The reinforcement plate 18 includes a body portion 24 and a pair of flange portions 26. The body portion 24 extends between the flange portions 26. The reinforcement plate 18 defines a length L and a width W. The body portion 24 is disposed along a substantial portion of the width W of the reinforcement plate 18 and extends along the entire length L of the reinforcement plate 18. It should be understood that the actual length, width and thickness of the reinforcement plate will vary depending upon design specific parameters, including but not limited to, the model of vehicle and the type of door handle included with the vehicle door.

The body portion 24 of the reinforcement plate 18 includes a latch opening 28 and at least one fastener opening 30. In one example, the body portion 24 includes two fastener openings 30. Although two fastener openings 30 are shown in FIG. 3, it should be understood that the actual number, size and shape of fastener openings 30 will depend upon the type of door handle 12 included with the vehicle door 10. The latch opening 28 receives the latch mechanism 20 of the door handle 12 where mounted to the vehicle door 10. In one example, the shape of the latch opening 28 directly corresponds to the shape of the latch mechanism 20. A worker of ordinary skill in the art having the benefit of this disclosure would be able to design the latch opening 28 to receive any latch mechanism 20 of any door handle 12.

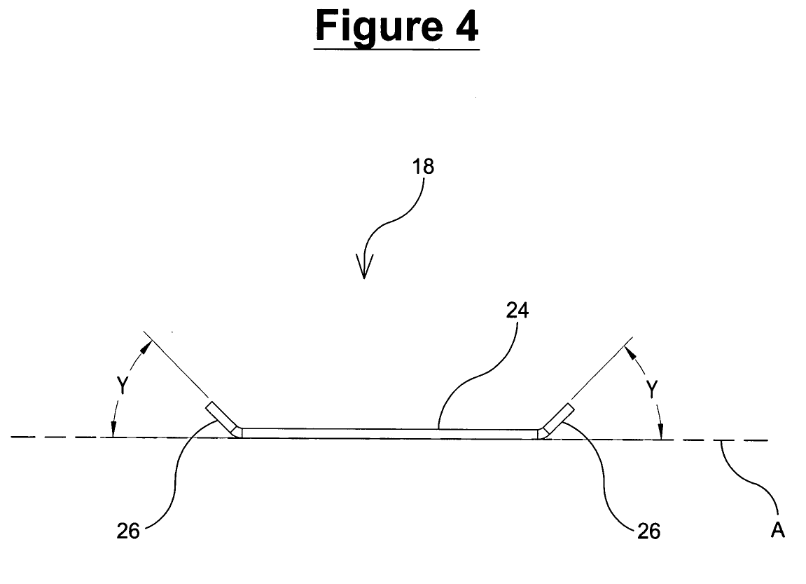

The flange portions 26 of the reinforcement plate 18 extend transversely from the body portion 24. In one example, the flange portions 26 extend at an angle Y of 45 degrees relative to an axis A defined by the body portion 24 (see FIG. 4). In another example, the flange portions 26 extend at an angle Y of 27.5 degrees relative to the axis A defined by the body portion 24. In yet another example, the flange portions 26 are angled at angle Y relative to the body portion 24 such that the body portion 24 contours the natural body line of the vehicle door 10. It should be understood that the actual angle Y of the flange portions 26 relative to the axis A of the body portion 24 will vary depending upon the design of the vehicle door and the door handle. The flange portions 26 provide strength and integrity to the reinforcement plate 18 when the reinforcement plate 18 is attached to the door handle 12.

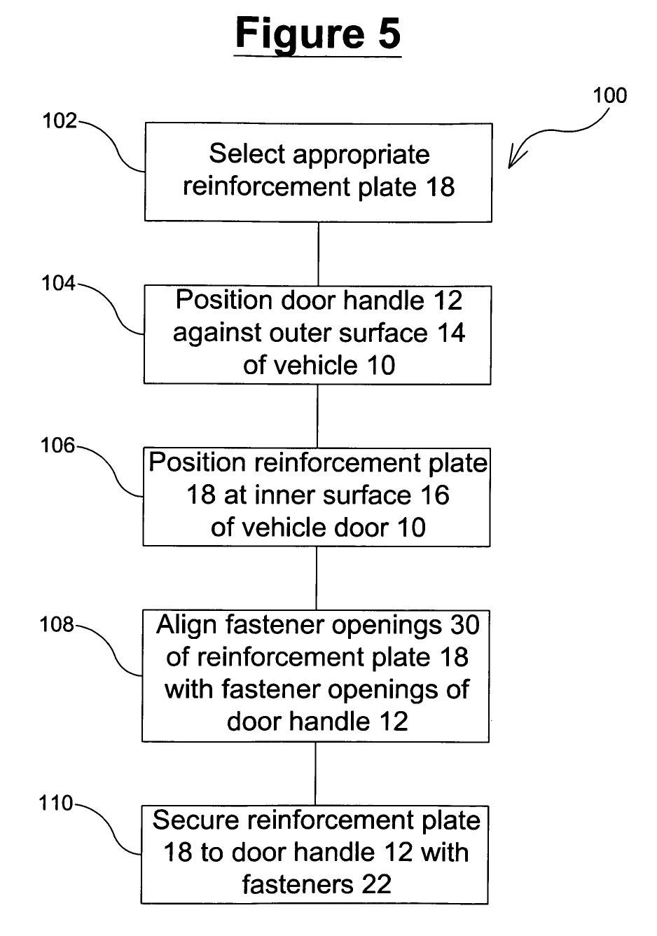

FIG. 5, with continuing reference to FIGS. 1-4, illustrates an example method 100 for reinforcing a door handle 12 of a vehicle door 10. At step block 102, an appropriate reinforcement plate 18 is selected based upon the model of vehicle and the type of door handle 12 included on the vehicle door 10 of the vehicle. For example, where the vehicle being restored is a 1970 Dodge Dart, an appropriate reinforcement plate 18 having a latch opening 28 and fastener openings 30 which correspond to the door handle 12 of the 1970 Dodge Dart is selected.

Next, at step block 104, the door handle 12 of the vehicle door 10 is at least partially inserted into openings of the vehicle door 10 to position the door handle 12 against the outer surface 14 of the vehicle door 10. Where required, such as where an entire new vehicle door 10 is necessary, holes may be drilled through the vehicle door 10 to receive the door handle 12.

The reinforcement plate 18 is positioned at the inner surface 16 of the vehicle door 10 at step block 106. In one example, the reinforcement plate 18 is positioned such that the flange portions 26 extend in a direction toward the inner compartment of the vehicle. The latch mechanism 20 of the door handle 12 is extended through the latch opening 28 of the reinforcement plate 18 and the reinforcement plate 18 is pushed directly against the inner surface 16 of the vehicle door 10 such that it is directly adjacent to the door handle 12. At step block 108, the fastener openings 30 of the reinforcement plate 18 are aligned with the existing fastener openings of the door handle 12.

Finally, at step block 110, the fasteners 22 are inserted into the fastener openings 30 at the inner surface 16 in a direction towards the outer surface 14 of the vehicle door 10. The fasteners 22 are torqued in a known manner to securely tighten the reinforcement plate 18 relative to the vehicle door 10 and to securely affix the door handle 12 to the outer surface 14 of the vehicle door 10. The reinforcement plate 18 provides structural integrity to the door handle 12 and the vehicle door 10 as the door handle 12 is pushed and pulled to open and close the vehicle door 10. That is, the reinforcement plate 18 distributes the forces that result from pushing and pulling on the door handle 12 over a greater area of the vehicle door 10 to increase the stiffness and strength of the mounting of the door handle 12.

The foregoing description shall be interpreted as illustrative and not in any limiting sense. A worker of ordinary skill in the art would recognize that certain modifications would come within the scope of this invention. For that reason, the following claim should be studied to determine the true scope and content of this invention.

What is claimed is:

1. A reinforcement plate for a vehicle door handle, comprising:
a body portion; and
at least one flange portion extending from said body portion at an angle that is transverse to said body portion, wherein said body portion includes at least one latch opening and at least one fastener opening, said at least one latch opening receiving a portion of the vehicle door handle.

2. A reinforcement plate for a vehicle door handle according to claim 1, wherein the plate is stamped above or below the mounting holes, so the plate cross section contour that contacts the vehicle door matches the contour of the desired vehicle door.

3. A reinforcement plate for a vehicle door handle according to claim 1, wherein the plate is bent above or below the mounting holes, so the plate cross section contour that contacts the vehicle door matches the contour of the desired vehicle door.

4. A reinforcement plate for a vehicle door handle according to claim 1, wherein the flanges on the plate 26 (FIG. 3) may be notched for clearance of the inner door structure.
